(19) United States
(12) Patent Application Publication
(10) Pub. No.: US 2007/0195971 A1
(43) Pub. Date: Aug. 23, 2007

(54) Collapsible speaker and headliner

(76) Inventor: Anthony Bongiovi, Port St. Lucie, FL (US)

Correspondence Address: Sheppard Mullin Richter & Hampton LLP, 11th Floor, 1300 I Street NW, Washington, DC, 20005, US

(21) Appl. No.: 11/703,216

(22) Filed: Feb. 7, 2007

Related U.S. Application Data
(60) Provisional application No. 60/765,722, filed on Feb. 7, 2006.

(51) Int. Cl. H04B 1/00; H04R 1/02

(52) U.S. Cl. 381/86; 381/389

(57) ABSTRACT

An acoustic speaker, and a headliner associated with one or more speakers, such that for each speaker, when impacted, the resultant HIC is less than 1000, where HIC is calculated by the following formula:

$$HIC = 0.75446 ( {[ \frac{1}{( {t}_{2} - {t}_{1} )} {\int }_{{t}_{1}}^{{t}_{2}} a ⅆ t ]}^{2.5} ( {t}_{2} - {t}_{1} ) ) + 166.4 ,$$

wherein the term a is the resultant acceleration of the headform expressed as a multiple of g (the acceleration of gravity), and t₁ and t₂ are any two points in time during the impact which are separated by not more than a 36 millisecond time interval. In order to effectuate this, the basket of the speaker may be deformable.

### CROSS REFERENCE TO RELATED APPLICATIONS

This application claims the benefit, under 35 U.S.C. §119, of provisional U.S. Application Ser. No. 60/765,722, filed Feb. 7, 2006, the entire contents and substance of which is hereby incorporated by reference.

### FIELD OF THE INVENTION

The present invention relates to an acoustic speaker, and more particularly, an acoustic speaker that, when impacted by the body of and specifically by the head of an occupant of a vehicle, causes minimal injury to that occupant. The present invention also relates to a vehicle headliner associated with one or more speakers.

### BACKGROUND OF THE INVENTION

The presentation of quality sound production in moving motor vehicles is particularly challenging due to the high noise content of the environment in which the sound is presented. This is compounded by the positioning of speakers, which often requires that the sound waves produced by the speakers bounce off of various surfaces before reaching the occupants of the vehicle. One solution to this problem is to place speakers in the headliner of the motor vehicle, thus removing the need for the sound waves to bounce off the aforementioned surfaces and allowing those waves to reach the occupants of the vehicle unhindered.

Further, each year, injuries to the head are responsible for tens of thousands of deaths and hundreds of thousands of hospitalizations in the United States alone. Many of these injuries are the result of motor vehicle crashes. A vehicle's occupant who, during a crash, strikes his head upon a conventional speaker mounted in the headliner of a motor vehicle could suffer serious injuries as a result.

Therefore, there is a need for a speaker in a motor vehicle that when impacted by the body of and specifically by the head of an occupant of the vehicle, causes minimal injury to that occupant. This speaker could be mounted on, embedded in, or otherwise associated with the headliner of a motor vehicle, or any other surface where the minimalization of injury is desired, such as in airplanes, helicopters, trains, boats, children's toys, bed headboards, and helmets. There is also a need for a headliner for a motor vehicle associated with one or more speakers that when impacted by the body of and specifically by the head of an occupant of the vehicle, causes minimal injury to that occupant. The headliner could also be used in other situations, such as in other modes of transportation such as airplanes, trains, and helicopters.

### SUMMARY OF THE INVENTION

A specific claim of the present invention comprises a speaker comprising a magnet, a cone, and a basket, wherein said speaker has a top side and a bottom side; wherein said bottom side of said speaker is the plane intersecting all points on the circumference of the basket at the point where that circumference is at its largest; wherein when said bottom side is impacted at one or more points on the surface of said bottom side opposite of said top side by a headform traveling at any speed up to and including 25 km/hour, the resultant HIC is less than 1,000; wherein said HIC is calculated by the following formula:

$$HIC = 0.75446 ( {[ \frac{1}{( {t}_{2} - {t}_{1} )} {\int }_{{t}_{1}}^{{t}_{2}} a ⅆ t ]}^{2.5} ( {t}_{2} - {t}_{1} ) ) + 166.4$$

and wherein the term a is the resultant acceleration of the headform expressed as a multiple of g (the acceleration of gravity), and t₁ and t₂ are any two points in time during the impact which are separated by not more than a 36 millisecond time interval.

In another aspect of the invention, the headform that impacts the speaker weighs up to about 4.59 kg. In yet another aspect, the headform that impacts the speaker weighs about 4.54 kg. According to another aspect, the headform that impacts the speaker comprises an aluminum skull, a steel skull cap plate, a 6-axis upper neck load simulator, a head skin and three (3) accelerometers.

In yet another aspect of the invention, when the headform impacts the speaker, the headform has traveled at least 25 mm prior to impacting the speaker. In another claim, the basket of the speaker is deformable. In yet another claim, the basket of the speaker is deformable when impacted by the headform.

In yet another aspect of the invention, the basket of the speaker is formed of a substance selected from the group consisting of aluminum, steel, titanium, any other metal, plastic, plastic composite, polypropylene, polycarbonate, and foam.

Also in order to meet the above stated need, one aspect of the invention is to provide a headliner for an automobile, wherein said headliner has one or more speakers associated with it, wherein when said headliner is impacted at one or more points on the surface of said bottom side opposite of said top side by a headform traveling at any speed up to and including 25 km/hour, the resultant HIC is less than 1,000; wherein said HIC is calculated by the following formula:

$$HIC = 0.75446 ( {[ \frac{1}{( {t}_{2} - {t}_{1} )} {\int }_{{t}_{1}}^{{t}_{2}} a ⅆ t ]}^{2.5} ( {t}_{2} - {t}_{1} ) ) + 166.4$$

and wherein the term a is the resultant acceleration of the headform expressed as a multiple of g (the acceleration of gravity), and t₁ and t₂ are any two points in time during the impact which are separated by not more than a 36 millisecond time interval.

In another aspect of the invention, the headform that impacts the headliner weighs up to about 4.59 kg. In yet another aspect, the headform that impacts the headliner weighs about 4.54 kg. According to another aspect, the headform that impacts the headliner comprises an aluminum skull, a steel skull cap plate, a 6-axis upper neck load simulator, a head skin and three (3) accelerometers.

In yet another aspect of the invention, when the headform impacts the headliner, the headform has traveled at least 25 mm prior to impacting the headliner. In another claim, when the headform impacts the headliner, the headform impacts one of the one or more speakers associated with the headliner.

In yet another claim, the one or more speakers associated with the headliner each comprise a magnet, a cone, and a basket. In another claim, the basket of each of the one or more speakers associated with the headliner is deformable. In yet another claim, the basket of each of the one or more speakers associated with the headliner is deformable when impacted by the headform.

In yet another aspect of the invention, the basket of each of the one or more speakers associated with the headliner is formed of a substance selected from the group consisting of aluminum, steel, titanium, any other metal, plastic, plastic composite, polypropylene, polycarbonate, and foam.

### BRIEF DESCRIPTION OF THE DRAWINGS

FIG. 1 illustrates a cross section of a speaker, according to aspects of an claim of the invention.

FIG. 2 illustrates a potential impact between a headform and a speaker, according to aspects of an claim of the invention.

FIG. 3 illustrates a potential impact between a headform and a headliner, according to aspects of an claim of the invention.

FIG. 4 illustrates a cross section of a speaker associated with a headliner, according to aspects of an claim of the invention.

### DETAILED DESCRIPTION OF THE PREFERRED CLAIM

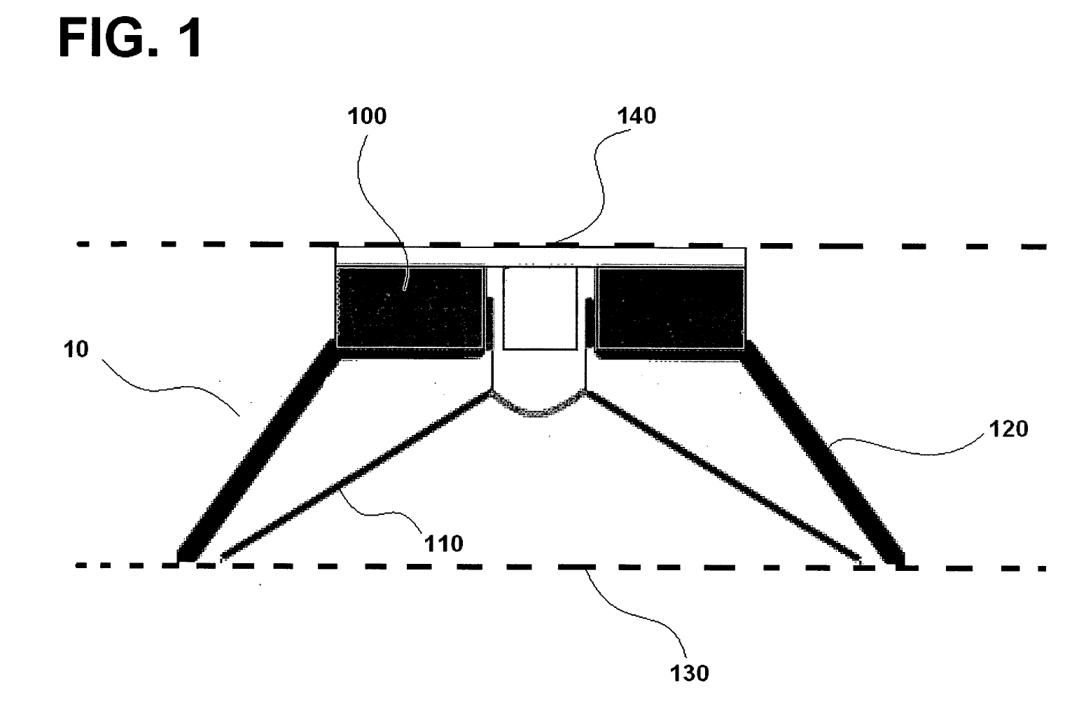

In one claim, the collapsible speaker of the invention may be constructed as shown in FIG. 1. Referring initially to FIG. 1, there is shown a cross-sectional view of a speaker 10 that comprises a magnet 100, a cone 110, a basket 120, a bottom side 130, and a top side 140. The speaker may advantageously be connected to or otherwise associated with an audio source such as an amplifier, receiver, cellular telephone, or any other device capable of producing audio signals. The speaker 10 may be attached to, embedded in, or otherwise associated with a headliner of a motor vehicle such as a car, truck, van, or other automobile. Alternatively, the speaker 10 may be associated with any other surface where there is a potential for impact with a human or other fragile object, and the minimalization of injury is desired. Examples of such surfaces include other surfaces in motor vehicles; surfaces in airplanes, helicopters, boats, and trains; children's toys; children's playpens; bed headboards; and helmets.

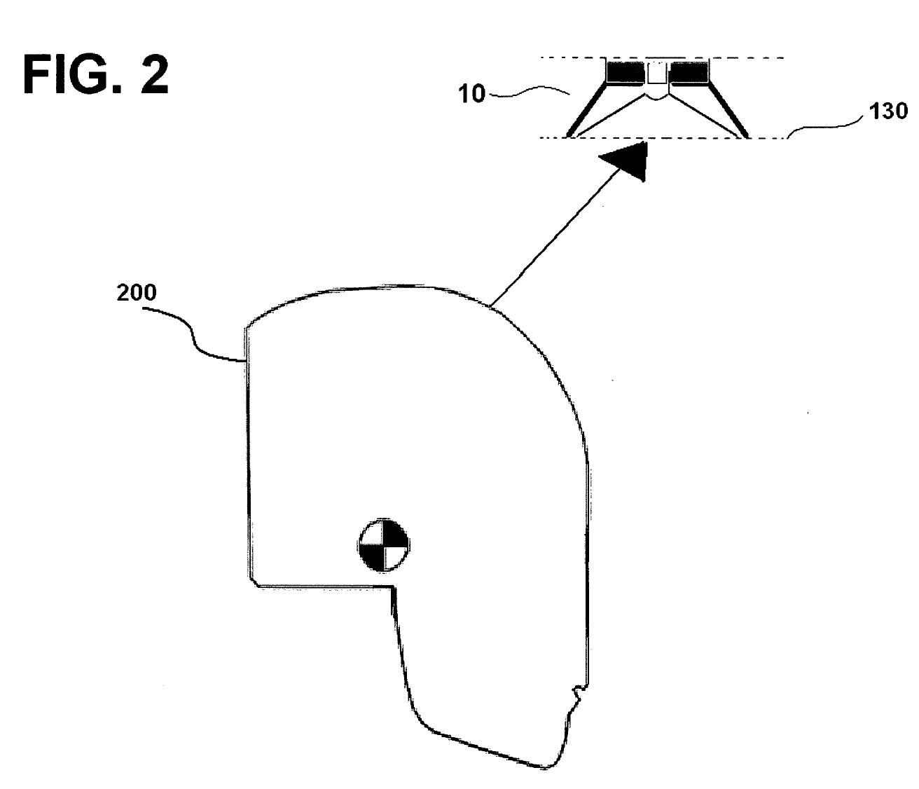

FIG. 2 illustrates a potential collision between headform 200 and bottom side 130 of speaker 10. When headform 200, traveling at any speed up to and including 25 km/hour, impacts bottom side 130 of speaker 10, the resultant HIC is less than 1,000, when the HIC is calculated using the following formula:

$$HIC = 0.75446 ( {[ \frac{1}{( {t}_{2} - {t}_{1} )} {\int }_{{t}_{1}}^{{t}_{2}} a ⅆ t ]}^{2.5} ( {t}_{2} - {t}_{1} ) ) + 166.4 ,$$

wherein the term a is the resultant acceleration of the headform expressed as a multiple of g (the acceleration of gravity), and t₁ and t₂ are any two points in time during the impact which are separated by not more than a 36 millisecond time interval.

When a traditional speaker is impacted, the basket does not properly deform, and can cause significant injury. Thus, in one claim of the invention, the basket 120 may be deformable, and may be deformable specifically when impacted by headform 200, or the body, and specifically the head of a person, thus reducing the injury caused upon impact. The basket 120 may also, after impact, reform into its original shape.

The basket 120 may advantageously be formed of one or more substance selected from the group comprising, but not limited to, aluminum, steel, titanium, any other metal, plastic, plastic composite, polypropylene, polycarbonate, and foam. The basket 120 is preferably strong enough to maintain its shape in a manner conducive to producing sound. The basket 120 may also be constructed in a manner that allows it to deform, specifically when impacted. This could be done using a gauge of metal, or thickness of other material, which is strong enough to maintain its shape for acoustic purposes, yet weak enough to deform upon impact. Alternatively, it could be done by creating weak spots in the basket 120, such that those spots would give way upon impact, allowing the basket 120 to be deformed. To determine is a particular basket 120 configuration is suitable for the invention, one skilled in the art could construct a prototype speaker 10, impact it with a headform 200, and calculate the resultant HIC. If that HIC is less than 1000, the basket 120 is suitable for use in the speakers and headliner of the present invention.

One such speaker 10 may have a 57 millimeter diameter at the point where the circumference of the basket 120 is at its largest and/or be 13 millimeters tall. Such a speaker 10 may also have one or more of an impedance of 8 ohms, a resonant frequency of 280 Hertz, a frequency range of around 150 Hertz to around 9,000 Hertz, and a sensitivity of around 86 decibels. The basket 120 of this speaker 10 may be formed of an appropriate gauge of aluminum. In this configuration, the aluminum is strong enough to maintain the shape of the basket for acoustic purposes, yet weak enough to deform upon impact.

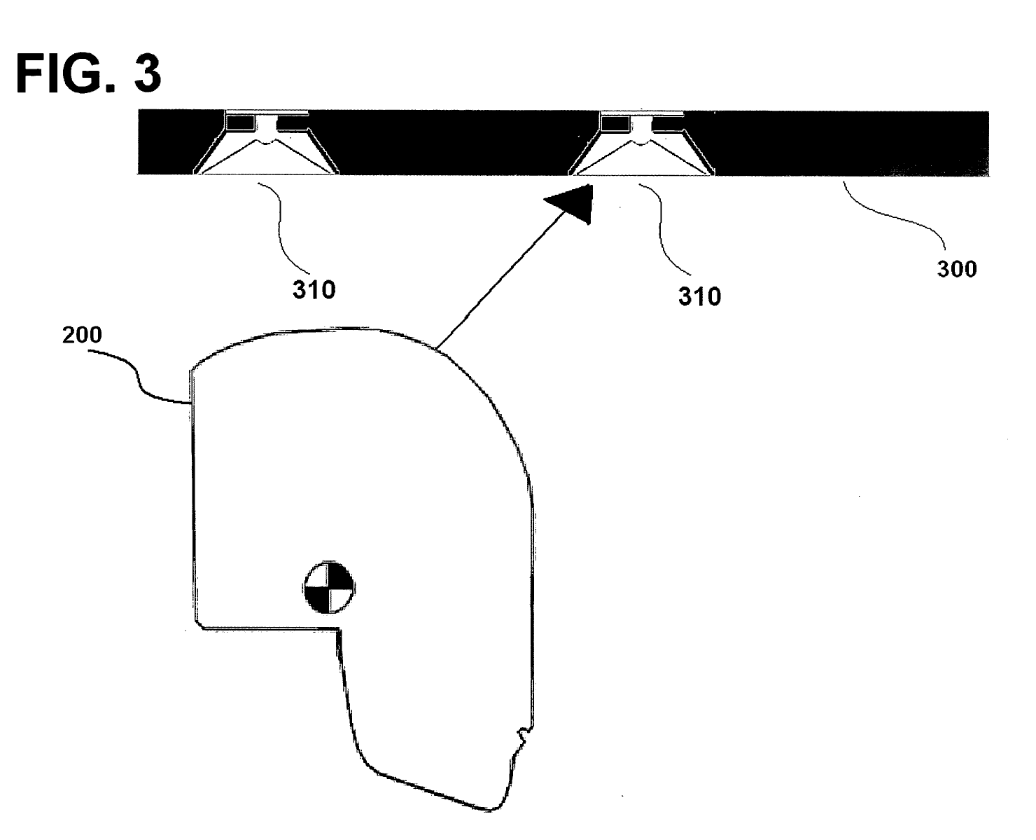

FIG. 3 illustrates a potential collision between headform 200 and headliner 300, which is associated with two speakers 310. The speakers 310 could alternatively be embedded in, attached to, mounted on, or otherwise associated with headliner 300. Further, headliner 300 need not be associated with two speakers, but may be associated with one speaker, or more than one speakers. When headform 200, traveling at any speed up to and including 25 km/hour, impacts headliner 300, the resultant HIC is less than 1,000, when the HIC is calculated using the following formula:

$$HIC = 0.75446 ( {[ \frac{1}{( {t}_{2} - {t}_{1} )} {\int }_{{t}_{1}}^{{t}_{2}} a ⅆ t ]}^{2.5} ( {t}_{2} - {t}_{1} ) ) + 166.4 ,$$

wherein the term a is the resultant acceleration of the headform expressed as a multiple of g (the acceleration of gravity), and t₁ and t₂ are any two points in time during the impact which are separated by not more than a 36 millisecond time interval.

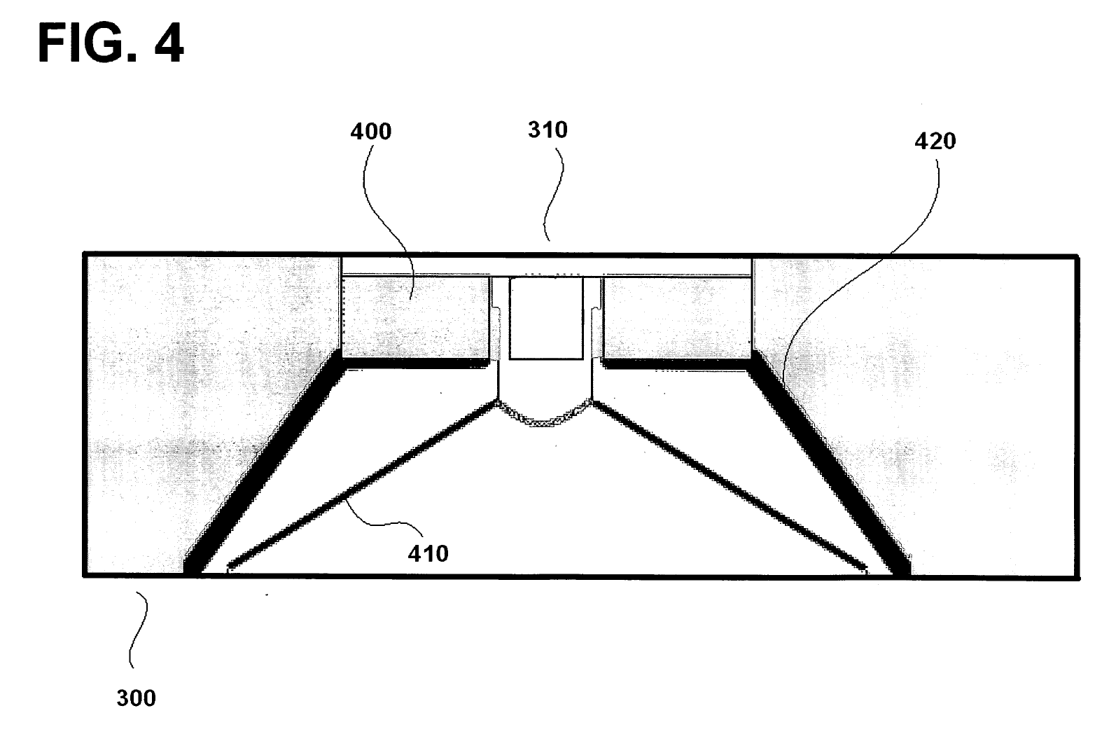

FIG. 4 shows a sectional view of speaker 310, associated with a headliner 300. Speaker 310 may comprise a magnet 400, a cone 410, and a basket 420. In one claim of the invention, the basket 420 may be deformable, and may be deformable specifically when impacted by headform 200 or the body, and specifically the head of a person, thus reducing the injury caused upon impact. The basket 420 may also, after impact, reform into its original shape.

The basket 420 may advantageously be formed of a substance selected from the group comprising, but not limited to, aluminum, steel, titanium, any other metal, plastic, plastic composite, polypropylene, polycarbonate, and foam. The basket 420 must be strong enough to maintain its shape in a manner conducive to producing sound. The basket 420 may also be constructed in a manner that allows it to deform, specifically when impacted. This could be done using a gauge of metal, or thickness of other material, which is strong enough to maintain its shape for acoustic purposes, yet weak enough to deform upon impact. Alternatively, it could be done by creating weak spots in the basket 420, such that those spots would first give way, deform, or collapse upon impact, allowing the basket 420 to be deformed. To determine is a particular basket 420 configuration is suitable for the invention, one skilled in the art could construct a prototype headliner 300 associated with one or more speakers 310, impact it with a headform 200, and calculate the resultant HIC. If that HIC is less than 1000, the basket 420 is suitable for the invention.

One such speaker 310 may have a 57 millimeter diameter at the point where the circumference of the basket 420 is at its largest and/or be 13 millimeters tall. Such a speaker 10 may also have one or more of an impedance of 8 ohms, a resonant frequency of 280 Hertz, a frequency range of around 150 Hertz to around 9,000 Hertz, and a sensitivity of around 86 decibels. The basket 420 of this speaker 310 may be formed of an appropriate gauge of aluminum. In this configuration, the aluminum is strong enough to maintain its shape for acoustic purposes, yet weak enough to deform upon impact.

One such headform 200 may be as defined in 49 CFR § 572.100 et. seq. This section of 49 CFR describes the free motion headform to be used in testing procedures described in 49 CFR § 571.201, a regulation relating to automobile occupant protection. Functionally, the speaker and headliner of the invention are meant to comply with this regulation, as well as any other present or future similar regulations.

Headform 200 may advantageously be any weight up to about 4.59 kg, and may particularly weigh about 4.54 kg. Headform 200 may comprise an aluminum skull, a steel skull cap plate, a 6-axis upper neck load simulator, a head skin and three (3) accelerometers. Headform 200 may also advantageously have traveled at least 25 mm before impacting bottom side 130 of speaker 10. Headform 200 may also advantageously have traveled at least 25 mm before impacting headliner 300.

It is to be understood that the above-described claims are illustrative of only a few of the many possible specific claims which can represent applications of the principles of the invention. Numerous and various other arrangements can be made by those skilled in the art without departing from the spirit and scope of the invention.

I claim:

1. A speaker comprising:
a magnet, a cone, and a basket;
wherein said speaker has a top side and a bottom side;
wherein said bottom side of said speaker is the plane intersecting all points on the circumference of the basket at the point where that circumference is at its largest;
wherein when said bottom side is impacted at one or more points on the surface of said bottom side opposite of said top side by a headform traveling at any speed up to and including 25 km/hour, the resultant HIC is less than 1,000;
wherein said HIC is calculated by the following formula:
$$HIC = 0.75446 ( {[ \frac{1}{( {t}_{2} - {t}_{1} )} {\int }_{{t}_{1}}^{{t}_{2}} a ⅆ t ]}^{2.5} ( {t}_{2} - {t}_{1} ) ) + 166.4$$
and wherein the term a is the resultant acceleration of the headform expressed as a multiple of g (the acceleration of gravity), and t₁ and t₂ are any two points in time during the impact which are separated by not more than a 36 millisecond time interval.

2. The speaker of claim 1, wherein said headform weighs up to about 4.59 kg.

3. The speaker of claim 2, wherein said headform weighs about 4.54 kg.

4. The speaker of claim 2, wherein said headform comprises an aluminum skull, a steel skull cap plate, a 6-axis upper neck load simulator, a head skin and three (3) accelerometers.

5. The speaker of claim 1, wherein when said headform impacts said speaker, said headform has traveled at least 25 mm prior to impacting said speaker.

6. The speaker of claim 1, wherein said basket is deformable.

7. The speaker of claim 1, wherein said basket is deformable when impacted by said headform.

8. The speaker of claim 1, wherein said basket is formed of a substance selected from one or more of the group consistency of, aluminum, steel, titanium, any other metal, plastic, plastic composite, polypropylene, polycarbonate, and foam.

9. A headliner for an automobile:
wherein said headliner has one or more speakers associated with it;
wherein when said headliner is impacted at one or more points by a headform traveling at any speed up to and including 25 km/hour, the resultant HIC is less than 1,000
wherein said HIC is calculated by the following formula:
$$HIC = 0.75446 ( {[ \frac{1}{( {t}_{2} - {t}_{1} )} {\int }_{{t}_{1}}^{{t}_{2}} a ⅆ t ]}^{2.5} ( {t}_{2} - {t}_{1} ) ) + 166.4$$
and wherein the term a is the resultant acceleration of the headform expressed as a multiple of g (the acceleration of gravity), and t₁ and t₂ are any two points in time during the impact which are separated by not more than a 36 millisecond time interval.

10. The headliner of claim 9, wherein said headform weighs up to 4.59 kg.

11. The headliner of claim 10, wherein said headform weighs about 4.54 kg.

12. The headliner of claim 9, wherein said headform comprises an aluminum skull, a steel skull cap plate, a 6-axis upper neck load simulator, a head skin and three (3) accelerometers.

13. The headliner of claim 9, wherein when said headform impacts said headliner, said headform has traveled at least 25 mm prior to impacting said headliner.

14. The headliner of claim 9, wherein when said headform impacts said headliner, said headform impacts one of said one or more speakers.

15. The headliner of claim 9, wherein said one or more speakers each comprise a magnet, a cone, and a basket.

16. The headliner of claim 15, wherein said basket is deformable.

17. The headliner of claim 15, wherein said basket is deformable when impacted by said headform.

18. The headliner of claim 15, wherein said basket is formed of a substance selected from one or more of the group consisting of aluminum, steel, titanium, any other metal, plastic, plastic composite, polypropylene, polycarbonate, and foam.
